(19) United States
(12) Patent Application Publication
(10) Pub. No.: US 2025/0116543 A1
(43) Pub. Date: Apr. 10, 2025

(54) BEVERAGE TRACKING SYSTEMS AND RELATED APPARATUSES

(71) Applicant: Neuro Tech LLC, Ladera Ranch, CA (US)

(72) Inventor: Arun Ramanathan, Ladera Ranch, CA (US)

(21) Appl. No.: 18/906,087

(22) Filed: Oct. 3, 2024

Related U.S. Application Data
(60) Provisional application No. 63/588,000, filed on Oct. 5, 2023.
(60) Provisional application No. 63/574,725, filed on Apr. 4, 2024.

(51) Int. Cl. G01F 23/20; G01F 23/80

(52) U.S. Cl. CPC G01F 23/20; G01F 23/804

(57) ABSTRACT

Beverage tracking systems and related apparatuses are disclosed. An apparatus includes a first member, a second member, a displacement resistance mechanism, and a displacement sensor. The first member includes an at least substantially planar surface configured to support the beverage container thereon. The second member is configured to support the first member. The displacement resistance mechanism is configured to vary a displacement between the first member and the second member responsive to variations in forces pressing the first member and the second member together. The displacement sensor is configured to generate a displacement signal that varies with the variation of the displacement between the first member and the second member. A beverage tracking system includes the apparatus and a beverage server device configured to provide a beverage server graphical user interface (GUI). The beverage server GUI is configured to indicate the estimated beverage level.

### TECHNICAL FIELD

This disclosure relates generally to beverage tracking systems and related apparatuses to estimate an amount of beverage in a beverage container.

### BACKGROUND

In conventional scenarios within bars and restaurants, the service model for beverages relies heavily on the traditional approach of visual checks by serving staff. Servers are tasked with monitoring drink levels through visual observation, walking through a patron area to make rounds among tables and ensuring patrons are adequately served. This approach is inherently challenging, particularly during busy periods. Different servers may possess different levels of ability to accurately assess at a glance whether a patron needs a refill. Misjudgments or oversights may lead to delays in service, leaving patrons with empty glasses and potentially diminishing their overall experiences.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1A through FIG. 1K are views of an apparatus to estimate an amount of beverage in a beverage container, according to some embodiments;

FIG. 2 is a plan view of an example of a variable resistor that may be used as a displacement sensor of the apparatus of FIG. 1A through FIG. 1K, according to some embodiments;

FIG. 3 is a side view of a beverage container placed on a planar surface of the apparatus of FIG. 1A through FIG. 1K, according to some embodiments;

FIG. 4 is a graph of a displacement signal plotted as a function of distance between the first member and the second member of the apparatus of FIG. 1A through FIG. 1K;

FIG. 5 is a vertical cross-sectional view of a beverage container on the planar surface of the apparatus of FIG. 1A through FIG. 1K with the apparatus supported within a recess 506 in a surface of a table;

FIG. 6 is a side view of a beverage storage area, according to some embodiments;

FIG. 7 is a view of a portion of a restaurant or bar, according to some embodiments;

FIG. 8 is a view of a portion of a bar, according to some embodiments;

FIG. 9 is a block diagram of a beverage tracking system, according to some embodiments;

FIG. 10 is a plan view of an example of a beverage server graphical user interface (GUI), which may be presented on a beverage server device of the beverage tracking system of FIG. 9, according to some embodiments;

FIG. 11 is a plan view an example of the beverage server GUI of FIG. 10 responsive to a user selection of a “smart coaster 1” option of the beverage server GUI of FIG. 10;

FIG. 12 is a plan view of an example of the beverage server GUI of FIG. 10 and FIG. 11 responsive to a user selection of the “stats” selection at the bottom of the beverage server GUI of FIG. 10;

FIG. 13A and FIG. 13B illustrate a plan view of an example of the beverage server GUI of FIG. 10 through FIG. 12 responsive to a user selection of the “controls” selection at the bottom of the beverage server GUI of FIG. 10;

FIG. 14 is an example of another beverage tracking system, according to some embodiments; and

FIG. 15 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In beverage serving scenarios relying upon visual checks by serving staff to make sure beverages remain filled, misjudgments or oversights may lead to delays in service, leaving patrons with empty glasses and potentially diminishing the overall experience and establishment profits.

Beverage coasters serve to protect table and counter surfaces from liquid rings and stains. Coasters sometimes double as marketing tools, adorned with logos of beverage companies, branding for an establishment, or decorative designs. Apparatuses according to embodiments of the disclosure may serve the function of a beverage coaster, but may provide additional functionality. In some embodiments, an apparatus to estimate an amount of beverage in a beverage container includes a first member, a second member, a displacement resistance mechanism, and a displacement sensor. The first member includes an at least substantially planar surface configured to support the beverage container thereon. The second member is configured to support the first member. The displacement resistance mechanism is configured to vary a displacement between the first member and the second member responsive to variations in forces pressing the first member and the second member together. The displacement sensor is configured to generate a displacement signal that varies with the variation of the displacement between the first member and the second member.

In some embodiments, a beverage tracking system includes an apparatus configured to support a beverage container thereon and a beverage server device. The apparatus is configured to provide a displacement signal indicating an estimated beverage level of a beverage in the beverage container. The beverage server device is configured to provide a beverage server graphical user interface (GUI). The beverage server GUI is configured to indicate the estimated beverage level.

Apparatuses according to various embodiments may be used as smart beverage coasters. A smart beverage coaster equipped with the ability to communicate drink levels presents a multifaceted solution to enhance beverage service efficiency in bars, restaurants, and large gatherings. By providing real-time alerts to serving staff, these smart beverage coasters alleviate some of the pressure on beverage servers by pinpointing when and which customers require attention. This system enables staff to serve the right customer at the right time, significantly reducing the chances of a patron being left with an empty glass for too long—a scenario that often leads to dissatisfaction. Moreover, timely service interventions encourage customers to order additional drinks, potentially increasing sales. The ability to promptly meet customers' needs not only elevates the dining experience but also positively impacts the establishment's reputation, leading to better tips for the staff and favorable online reviews from happy customers. Beyond direct service improvements, the data collected from smart coasters can offer valuable insights into consumption patterns, enabling businesses to optimize their inventory and tailor promotions or special offers to peak drinking times. This strategic use of data can further enhance operational efficiency and customer satisfaction, demonstrating that the benefits of smart coasters extend well beyond the immediate convenience of alerting staff to empty glasses.

The data generated by smart coasters offers a wealth of opportunities for both businesses and customers, transforming the simple act of drinking into a source of valuable insights. For businesses, the analysis of drinking behavior may significantly enhance operational efficiency and customer satisfaction. This data can identify popular drinks and peak drinking times, allowing for better inventory management and staffing optimization. Moreover, understanding consumption patterns enables businesses to tailor promotions or special events to match customer preferences, potentially increasing sales and customer loyalty.

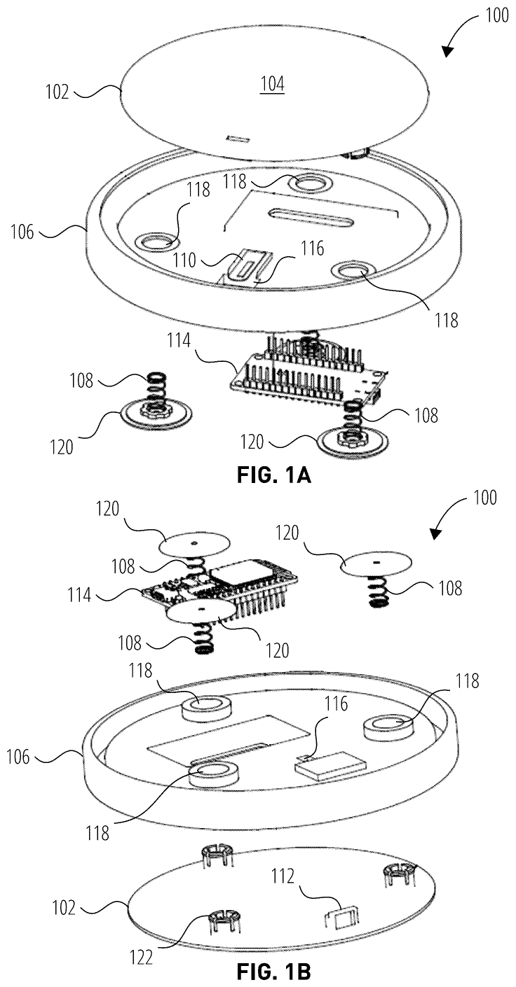

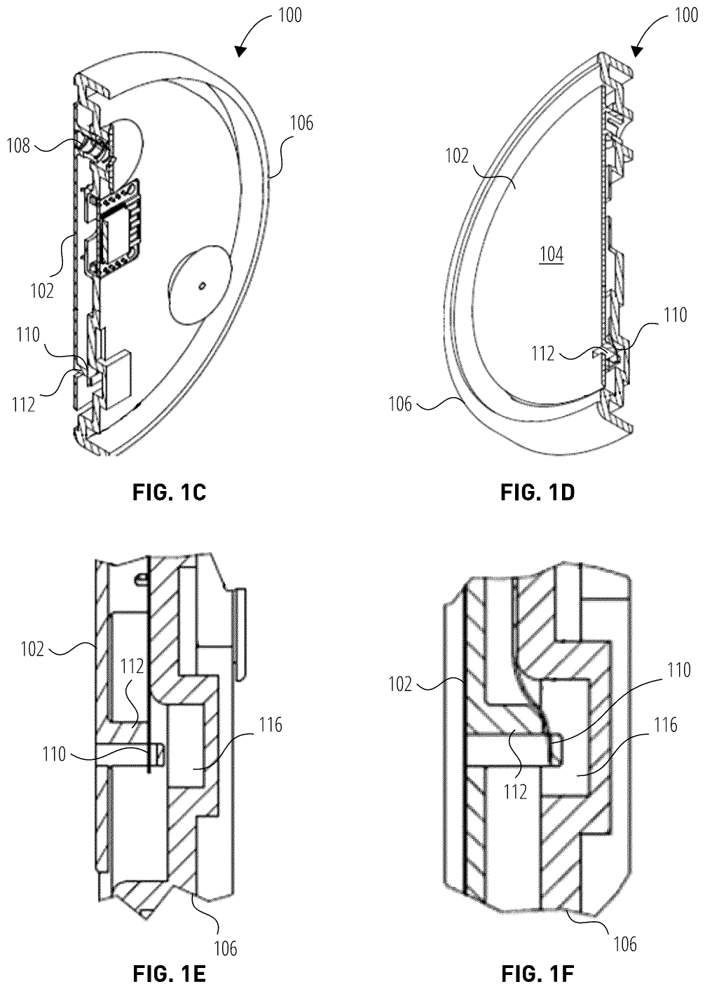

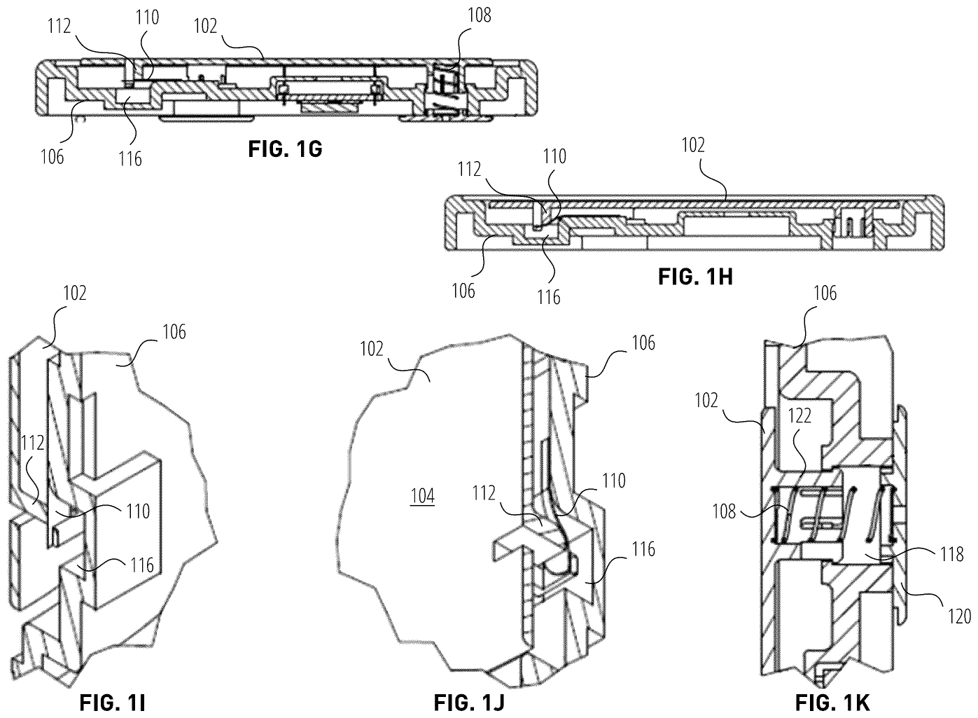

FIG. 1A through FIG. 1K are views of an apparatus 100 to estimate an amount of beverage in a beverage container, according to some embodiments. FIG. 1A and FIG. 1B are top and bottom perspective exploded views, respectively, of the apparatus 100. FIG. 1C is a bottom perspective view of the apparatus 100 with a portion of the apparatus 100 cut away. FIG. 1D is a top perspective view of the apparatus 100 with a portion of the apparatus 100 cut away. FIG. 1E and FIG. 1F are side cross-sectional views of a portion of the apparatus 100. FIG. 1G and FIG. 1H are cross-sectional views of the apparatus 100. FIG. 1I and FIG. 1J are perspective cross-sectional views of portions of the apparatus 100. FIG. 1K is a side cross-sectional view of the apparatus 100.

The apparatus 100 includes a first member 102, a second member 106, a displacement resistance mechanism 108, and a displacement sensor 110. The first member 102 includes an at least substantially planar surface 104 configured to support the beverage container thereon. The second member 106 is configured to support the first member 102. The displacement resistance mechanism 108 is configured to resist displacement of the first member 102 toward the second member 106. For example, the displacement resistance mechanism 108 may be configured to vary a displacement between the first member 102 and the second member 106 responsive to variations in forces pressing the first member 102 and the second member 106 together. The displacement sensor 110 is configured to generate a displacement signal that varies with the variation of the displacement between the first member 102 and the second member 106.

The second member 106 includes apertures 118 formed therein. The first member 102 includes snap fit connectors 122 extending toward the second member 106. The snap fit connectors 122 are configured to couple to the second member 106 at the apertures 118 to secure the first member 102 to the second member 106. Once snapped into the apertures 118, the snap fit connectors 122 may move back and forth further into and out from the apertures 118, but may be limited from being completely withdrawn from the apertures 118. For example, ends of the snap fit connectors 122 may be wider than entry points of the apertures 118 through which the snap fit connectors 122 enter the apertures 118, as perhaps best shown in FIG. 1K. In this way, the snap fit connectors 122 mechanically couple the first member 102 to the second member 106 while still allowing displacement of the first member 102 relative to the second member 106.

In some embodiments, the displacement resistance mechanisms 108 may include springs, as illustrated in FIG. 1A, FIG. 1B, FIG. 1C, FIG. 1G, and FIG. 1K. In some embodiments, the displacement resistance mechanism 108 may include one or more of springs, expanded foam, molded in features, elastomeric balls, or an elastomeric ring between the first member and the second member. The second member 106 is configured to receive the displacement resistance mechanisms 108 through the apertures 118. The displacement resistance mechanisms 108 are secured to mounts 120 configured to couple to the second member 106 at the apertures 118. For example, the mounts 120 may be configured to snap into the apertures 118 to secure the displacement resistance mechanism 108 into position. As another example, the mounts 120 may be secured to the second member 106 at the apertures 118 using a glue or adhesive. The displacement resistance mechanisms 108 may be held in position against the first member 102 by the snap fit connectors 122. For example, the displacement resistance mechanisms 108 may insert into the snap fit connectors 122 as illustrated in FIG. 1K.

The displacement resistance mechanisms 108 exert a force on the first member 102 and the second member 106 to separate the first member 102 from the second member 106 to a maximum displacement between the first member 102 and the second member 106 allowed by the snap fit connectors 122. FIG. 1C, FIG. 1E, FIG. 1G, FIG. 1I, and FIG. 1K illustrate the apparatus 100 with the first member 102 and the second member 106 at their maximum displacement allowed by the snap fit connectors 122. In some embodiments, the displacement resistance mechanisms 108 may be selected to exert sufficient force to support an empty beverage container on the planar surface 104 of the first member 102 with the first member 102 separated from the second member 106 at or near a maximum displacement allowed by the snap fit connectors 122. In this way, displacement between the first member 102 and the second member 106 less than the maximum displacement may be at least mostly caused by beverage in the beverage container (e.g., by the gravitation force exerted by the beverage container including the beverage on the first member 102 and a normal force exerted opposite to the gravitational force by a surface supporting the second member 106). In other words, the larger the quantity of beverage within a beverage container supported by the planar surface 104, the greater the displacement of the first member 102 toward the second member 106. FIG. 1D, FIG. 1F, FIG. 1H, and FIG. 1J illustrate the apparatus 100 in an at least partially deformed state (i.e., with the displacement between the first member 102 and the second member 106 less than the maximum displacement allowed by the snap fit connectors 122).

The second member 106 is configured to support the displacement sensor 110 at a sensor window 116 formed in the second member 106. The first member 102 includes an actuator 112 protruding therefrom. The actuator 112 is aligned with the sensor window 116 to enable the actuator 112 to engage with the displacement sensor 110. The actuator 112 may displace the displacement sensor 110 into the sensor window 116 responsive to the first member 102 displacing toward the second member 106. FIG. 1D, FIG. 1F, FIG. 1H, and FIG. 1J illustrate the displacement sensor 110 displaced into the sensor window 116 by the actuator 112. A larger displacement of the first member 102 toward the second member 106 causes a larger displacement of the displacement sensor 110 into the sensor window 116. FIG. 1C, FIG. 1E, FIG. 1G, and FIG. 1I illustrate the displacement sensor in a non-displaced state. Accordingly, a large amount of beverage in a beverage container supported on the planar surface 104 causes a large displacement of the displacement sensor 110 and a small amount of beverage in the beverage container causes a small displacement of the displacement sensor 110.

Although the apparatus 100 of FIG. 1A through FIG. 1K includes the displacement sensor 110 supported by the second member 106, in some embodiments, the first member 102 may support the displacement sensor 110 and the second member 106 may include an actuator to displace the displacement sensor 110 as the first member 102 is displaced toward the second member 106. Accordingly, more generically stated, the at least one of the first member 102 or the second member 106 includes an actuator 112 configured to displace the displacement sensor 110 responsive to the displacement between the first member 102 and the second member 106.

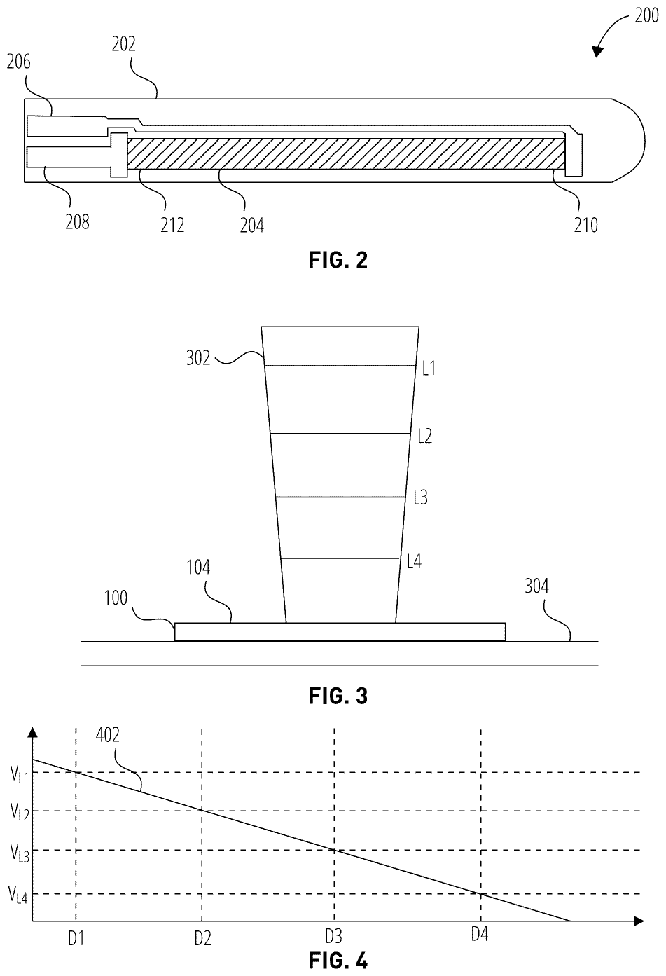

In some embodiments, the displacement sensor 110 includes a variable resistor configured to vary an electrical resistance of the of the variable resistor responsive to variations in a displacement of the variable resistor. Details of an example of a variable resistor that may be used for the displacement sensor 110 are discussed with reference to FIG. 2. The apparatus 100 also includes electronic circuitry 114 configured to receive a displacement signal indicating the displacement of the displacement sensor 110. By way of non-limiting example, where the displacement sensor 110 includes a variable resistor, the displacement sensor 110 may be electrically connected in series with another resistor of the electronic circuitry 114 to create a voltage divider circuit. A voltage potential may be applied across the voltage divider circuit and the displacement signal may be measured between the displacement sensor 110 and the other resistor. The displacement signal would therefore vary with displacement of the first member 102 relative to the second member 106. In some embodiments, the displacement sensor 110 may include another type of force sensitive resistor (e.g., a strain gauge), or a capacitive or piezo resistive device.

In some embodiments, the electronic circuitry 114 may include an analog to digital converter configured to convert the measured displacement signal to a digital displacement signal. The electronic circuitry 114 may also include communication circuitry configured to communicate the displacement signal to a central control circuitry. The electronic circuitry 114 is configured to transmit the displacement signal to a beverage server device to enable the beverage server device to indicate, to a beverage server, an estimate of a beverage level of a beverage of the beverage container supported by the at least substantially planar surface 104. By way of non-limiting example, the communication circuitry may include wireless communication circuitry (e.g., Bluetooth circuitry, WiFi circuitry, Zigbee circuitry, cellular data communication circuitry, etc.) configured to communicate the digital displacement signal to the central control circuitry. The central control circuitry may be configured to control provision of an indication of the amount of the beverage in the beverage container on the planar surface 104 to a beverage server (e.g., a bar tender, etc.) responsive to the displacement signal communicated by the electronic circuitry 114.

Although not shown in FIG. 1A through FIG. 1K, the apparatus 100 may include a power supply. By way of non-limiting example, the apparatus 100 may include one or more batteries (e.g., rechargeable batteries, button batteries, other batteries, etc.), a connector to receive a power cable operably coupled to a power source, or other power source. The power supply may provide electrical power to the electronic circuitry 114 to enable the electronic circuitry 114 to receive the electrical signal and communicate the digital electrical signal to the central control circuitry.

FIG. 2 is a plan view of an example of a variable resistor 200 that may be used as a displacement sensor 110 of the apparatus 100 of FIG. 1A through FIG. 1K, according to some embodiments. The variable resistor 200 includes a resilient substrate material 202 and an electrically resistive material 204 carried by the resilient substrate material 202. An electrical resistance of the electrically resistive material 204 is configured to increase as a displacement of the resilient substrate material 202 increases. The variable resistor 200 also includes a first electrode 206 and a second electrode 208 electrically connected across the electrically resistive material 204 to electrically connect the electrically resistive material 204 to the electronic circuitry 114 of the apparatus 100 of FIG. 1A through FIG. 1K. An example of the variable resistor 200 of FIG. 2 is the Bend Sensor®, manufactured by Flexpoint Sensor Systems, Inc., of West Jordan, Utah, and discussed in more detail in U.S. Pat. No. 5,157,372 to Gordon B. Langford, titled “Flexible Potentiometer,” and filed Jul. 13, 1990.

FIG. 3 is a side view of a beverage container 302 placed on a planar surface 104 of the apparatus 100 of FIG. 1A through FIG. 1K, according to some embodiments. In the example illustrated in FIG. 3, the beverage container 302 is a drinking glass and the apparatus 100 is functioning as a beverage coaster, which is supported on a top of a table 304.

Four different levels of beverage are illustrated in the beverage container 302. The four levels include a first level L1 corresponding to a nearly full beverage container 302, a second level L2 lower than the first level L1, a third level L3 lower than the second level L2, and a fourth level L4 lower than the third level L3.

The table 304 exerts a normal force upward against the apparatus 100 and the beverage container 302 and the beverage within exert a gravitational force downward against the apparatus 100. As a result, the first member 102 (FIG. 1A through FIG. 1K) displaces toward the second member 106 (FIG. 1A through FIG. 1K) at different displacements depending on the amount of beverage in the beverage container 302.

FIG. 4 is a graph of a displacement signal 402 plotted as a function of distance between the first member 102 (FIG. 1A through FIG. 1K) and the second member 106 (FIG. 1A through FIG. 1K) of the apparatus 100 of FIG. 1A through FIG. 1K. Referring to FIG. 3 and FIG. 4 together, in this example, the displacement signal 402 is greater corresponding to a higher level of the beverage in the beverage container 302 responsive to a smaller displacement between the first member 102 and the second member 106.

For example, at the highest beverage level L1 illustrated in FIG. 3, the distance D1 between the first member 102 and the second member 106 is relatively small. As a result, displacement signal 402 for beverage level L1 is at V_{L1}, which is higher than voltage potentials V_{L2}, V_{L3}, and V_{L4} corresponding to smaller distances D2, D3, and D4, respectively, which in turn correspond to lower beverage levels L2, L3, and L4, respectively. Also, at the lowest beverage level L4 illustrated in FIG. 3, the distance between the first member 102 and the second member 106 is relatively large. As a result, displacement signal 402 for beverage level L4 is at V_{L4}, which is lower than voltage potentials V_{L1}, V_{L2}, and V_{L3} corresponding to larger distances D1, D2, and D3, respectively, which in turn correspond to higher beverage levels L1, L2, and L3, respectively.

At the second highest beverage level L2 illustrated in FIG. 3, the distance D2 between the first member 102 and the second member 106 is larger than that D1 for beverage level L1, but smaller than those D3 and D4 for beverage levels L3 and L4, respectively. As a result, displacement signal 402 for beverage level L2 is V_{L2}, which is lower than voltage potential V_{L1} corresponding to beverage level L1, but higher than voltage potentials V_{L3} and V_{L4} for beverage levels L3 and L4, respectively. Also, at the second lowest beverage level L3 illustrated in FIG. 3, the distance D3 between the first member 102 and the second member 106 is smaller than that D4 for beverage level L4, but larger than those D1 and D2 for beverage levels L1 and L2, respectively. As a result, displacement signal 402 for beverage level L3 is V_{L3}, which is higher than voltage potential V_{L4} corresponding to beverage level L4, but lower than voltage potentials V_{L1} and V_{L2} for beverage levels L1 and L2, respectively.

In operation, a voltage potential level of the displacement signal generated from an empty beverage container may be set as a baseline to indicate an empty state to the electronic circuitry 114 (e.g., to software or firmware executed by the electronic circuitry 114). This would be a lowest voltage potential. A full drink with the same beverage container may be placed on the apparatus 100, and displacement of the displacement sensor 110 would increase the electrical resistance, which may increase a voltage potential of the displacement signal. A reading from the displacement signal with a full beverage container may be used as a highest voltage potential corresponding to a full beverage container.

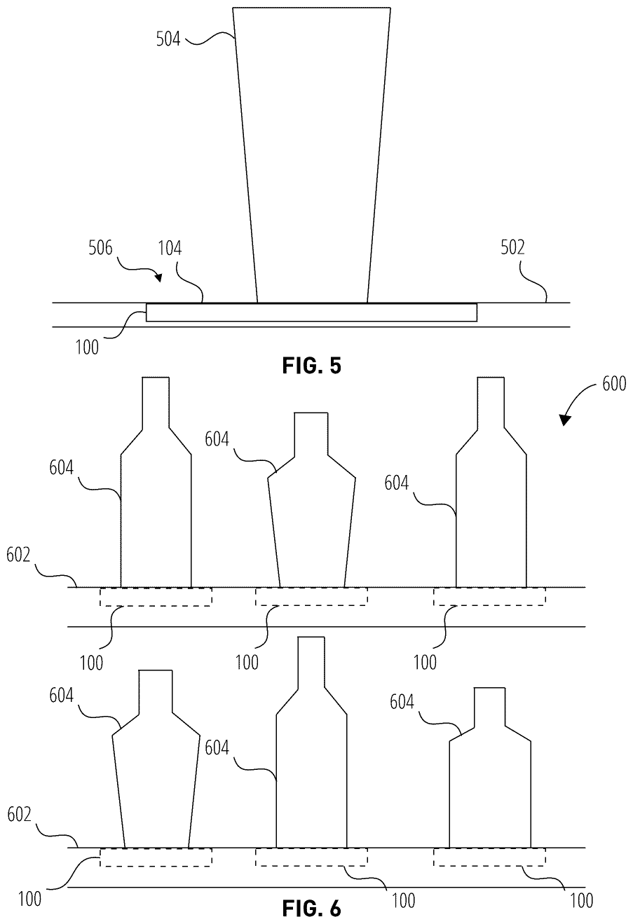

FIG. 5 is a vertical cross-sectional view of a beverage container 504 on the planar surface 104 of the apparatus 100 of FIG. 1A through FIG. 1K with the apparatus 100 supported within a recess 506 in a surface of a table 502. The planar surface 104 is at least substantially coplanar with the surface of the table. In this embodiment, the apparatus 100 may not protrude from the surface of the table, which may provide a less obstructive experience to a person drinking from the beverage container 504 and using the table 502 for other activities such as supporting food containers, plates, silverware, and other meal items.

FIG. 6 is a side view of a beverage storage area 600, according to some embodiments. The beverage storage area 600 includes shelves 602 and multiple instances of the apparatus 100 of FIG. 1A through FIG. 1K on or embedded in the shelves 602. In the example illustrated in FIG. 6, the apparatuses 100 are embedded in the shelves 602 (e.g., supported within recesses in the shelves 602).

The beverage containers supported by the apparatuses 100 illustrated in FIG. 6 are beverage bottles 604. Accordingly, each apparatus 100 may be configured to provide a displacement signal corresponding to an amount of beverage in its corresponding one of the beverage bottles 604 to central control circuitry. These displacement signals may enable a beverage server and other bar/restaurant staff to stay informed as to how much beverage is left in each of the beverage bottles 604. For example, a server may be informed as to whether a new bottle of a particular beverage should be retrieved from storage to replace a depleted one of the beverage bottles 604 in the beverage storage area 600. As another example, a person charged with managing inventory of beverages may be informed as to how much of each beverage is stored in the beverage storage area 600, which may enable the person to know when to order new bottles that are nearing depletion.

In some embodiments, apparatuses 100 used to monitor beverage levels in beverage bottles in a storage area may include displacement resistance mechanisms 108 having greater mechanical resistance than displacement resistance mechanisms 108 of apparatuses 100 for beverage glasses because a full beverage bottle is generally heavier than a beverage glass. Accordingly, a higher mechanical resistance for beverage bottles may prevent full compression of the apparatus 100 when the beverage bottle is full. A resistance of the displacement resistance mechanism 108 may be selected to take advantage of as much of a dynamic range of displacement of the apparatus 100 as possible.

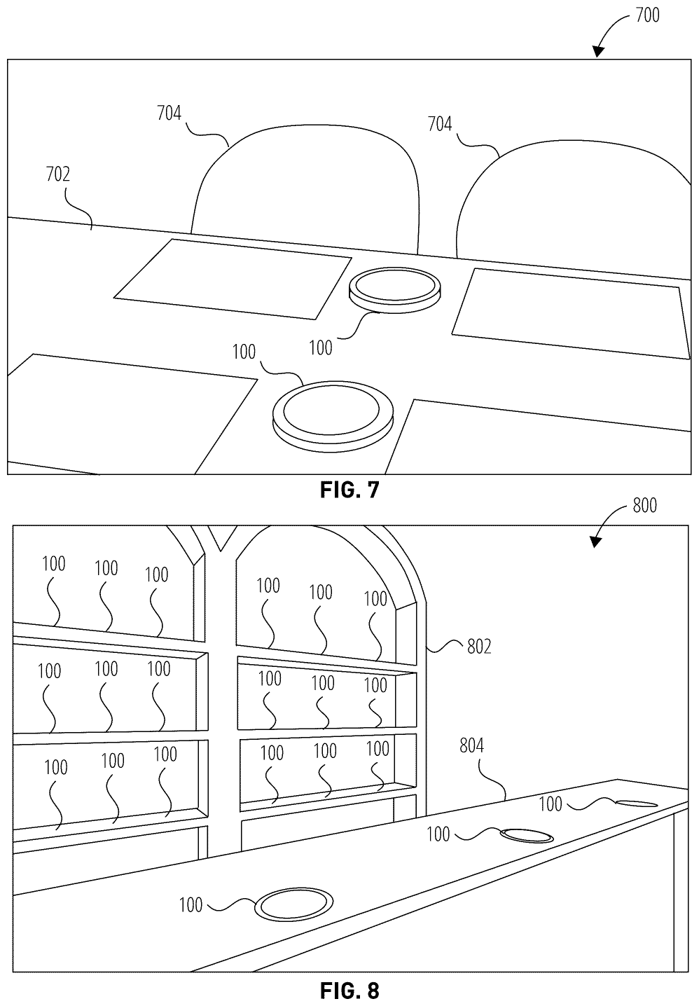

FIG. 7 is a view of a portion 700 of a restaurant or bar, according to some embodiments. The portion 700 includes a table 702, chairs 704 at the table 702, and apparatuses 100 to carry beverage containers (e.g., beverage glasses). A server may bring drinks to the table 702 and place the beverages on the apparatuses 100. The server may have access to a central control circuitry to monitor beverage levels in beverage glasses on the apparatuses 100. Accordingly, the server may monitor the beverage levels in the beverage glasses without making rounds through the restaurant or bar. Also, the server may stay on top of beverage refills because the server may stay informed of or may be alerted to empty or near empty beverage glasses.

FIG. 8 is a view of a portion 800 of a bar, according to some embodiments. The portion 800 includes a bar counter 804 and a set of shelves 802. The shelves 802 and the bar counter 804 include multiple instances of the apparatus 100 of FIG. 1A through FIG. 1K to enable servers and other personnel to track how much beverage is in beverage glasses for patrons and in beverage bottles stored on the shelves 802.

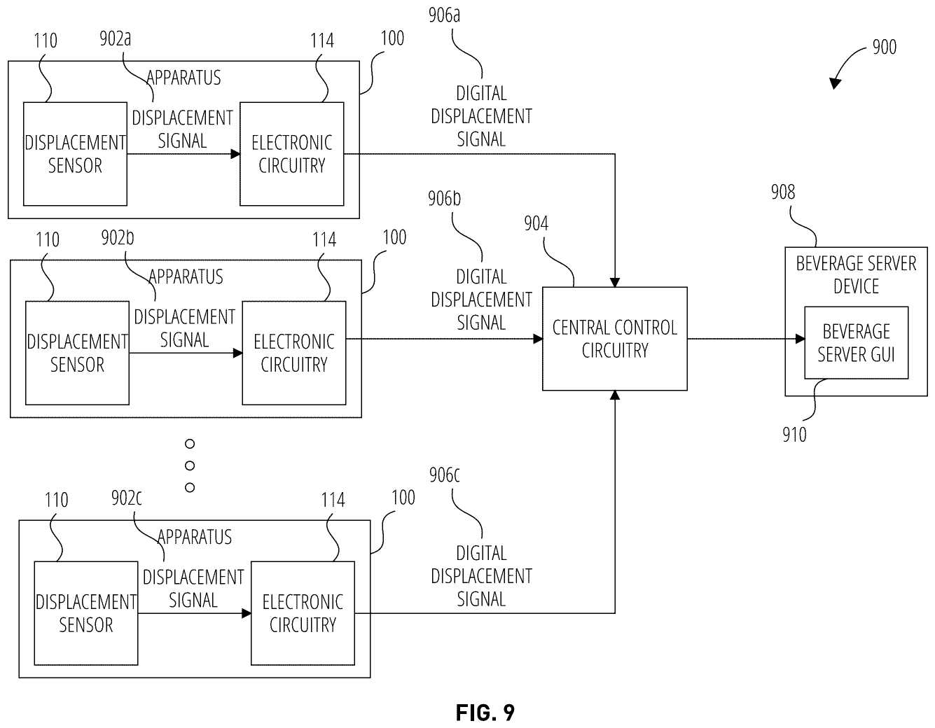

FIG. 9 is a block diagram of a beverage tracking system 900, according to some embodiments. The beverage tracking system 900 includes multiple instances of the apparatus 100 of FIG. 1A through FIG. 1K, a central control circuitry 904, and a beverage server device 908. As previously discussed, each instance of the apparatus 100 includes a displacement sensor 110 configured to provide a displacement signal (e.g., displacement signal 902a, displacement signal 902b, . . . , and displacement signal 902c) to electronic circuitry 114. The electronic circuitry 114 is configured to provide a digital displacement signal (e.g., digital displacement signal 906a, digital displacement signal 906b, . . . , and digital displacement signal 906c) to the central control circuitry 904. By way of non-limiting example, the electronic circuitry 114 may be configured to deliver the displacement signals to the central control circuitry 904 via wireless communications (e.g., Bluetooth, WiFi, Zigbee, cellular data networks, etc.), via a wired connection (e.g., Ethernet, a cable, wired Internet, etc.), or combinations thereof.

The central control circuitry 904 is configured to relay the digital displacement signals 906a, 906b, . . . , and 906c to the beverage server device 908. In some embodiments the central control circuitry 904 may be a computer running a software application programmed to receive and store the digital displacement signals 906a, 906b, . . . , and 906c and relay the digital displacement signals 906a, 906b, . . . , and 906c to the beverage server device 908. In some embodiments, the central control circuitry 904 may be a special purpose device designed and provided for the specific purpose of receiving and relay digital displacement signals 906a, 906b, . . . , and 906c locally at a beverage serving establishment (e.g., a restaurant, a bar, etc.). In some embodiments, the central control circuitry 904 may be implemented at a remote server (e.g., a cloud server). In some embodiments, the central control circuitry 904 may be implemented at the beverage server device 908. In some embodiments, the central control circuitry 904 may be implemented using a point of sale (POS) system of the establishment.

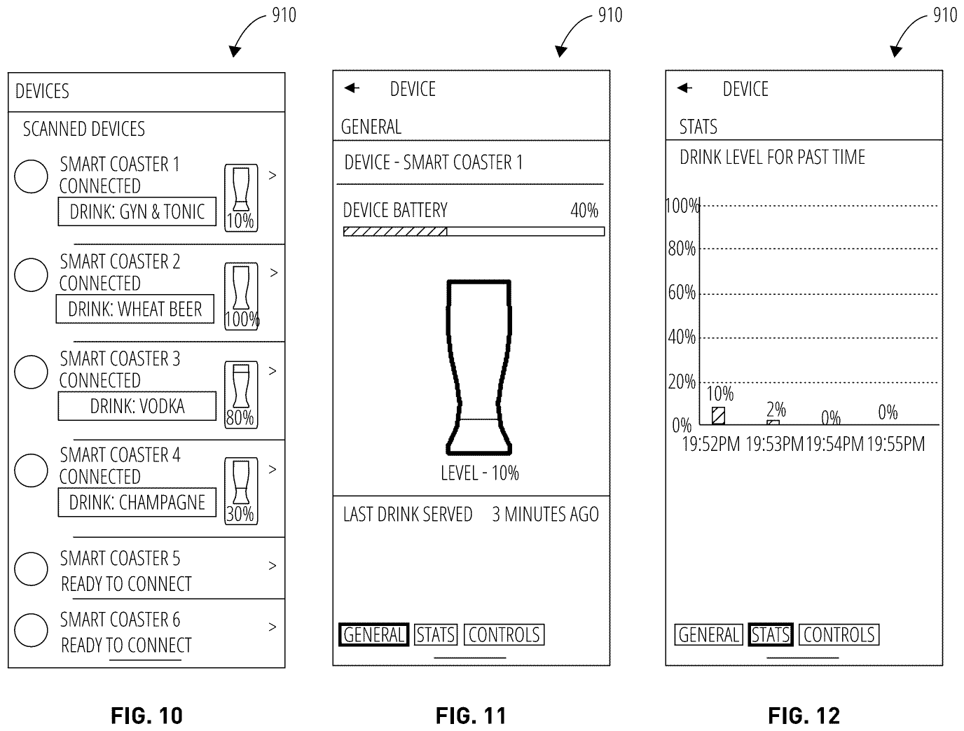

The beverage server device 908 may be a device used by a beverage server. By way of non-limiting example, the beverage server device 908 may include a mobile device (e.g., a smart phone, a tablet computer, etc.) executing a software application for a beverage server GUI 910. Also by way of non-limiting example, the beverage server device 908 may be implemented using a point of sale (POS) system of the establishment. The beverage server device 908 is configured to provide the beverage server GUI 910. The beverage server GUI 910 is configured to provide information such as estimates of how full beverages at the apparatuses 100 are. The beverage server GUI 910 may also provide other information, such as a state of charge of a batter of an apparatus 100 or trends of how full a beverage glass at an apparatus 100 has been over time. The beverage server GUI 910 may provide alarms and/or visual alerts when a beverage at one of the apparatuses 100 is empty or almost empty. The beverage server GUI 910 may also include controls for connecting to a new apparatus 100. By way of non-limiting example, the beverage server GUI 910 may enable the beverage server device 908 to utilize its camera device to scan a bar code or a quick response (QR) code on the apparatus 100 to facilitate easy and/or quick connection of the beverage server GUI 910 to the apparatus 100. FIG. 10, FIG. 11, and FIG. 12 illustrate examples of the beverage server GUI 910.

In some embodiments, the central control circuitry 904 may be implemented by the beverage server device 908. By way of non-limiting example, a single software app may implement the central control circuitry 904 and the beverage server GUI 910.

In some embodiments, some of the apparatuses 100 may be smart beverage coaster apparatuses configured to monitor beverage levels in beverage glasses at a table or counter where customers are enjoying beverages. In some embodiments, some of the apparatuses 100 may be beverage bottle apparatuses configured to monitor beverage levels in beverage bottles at a beverage storage area (e.g., the beverage storage area 600 of FIG. 6, the shelves 802 of FIG. 8, etc.). Accordingly, a beverage server may receive at least substantially real-time updates indicating customer drink levels as well as beverage inventory levels without the need to walk around and visually inspect tables, counters, storage areas, and/or shelves.

Every time a portion of the beverage is consumed by the customer, the voltage potential level of the displacement signals (e.g., displacement signal 902a, 902b, . . . , and 902c) would drop. As the drink level reaches a predetermined threshold value (e.g., 20% full), an alert may be provided (e.g., to a beverage server GUI 910). When the serving staff receives the alert about the customers' drink nearing empty, they would be prompted to approach said customer and inquire if they would like another drink. If the customer is not attended to until the drink is fully consumed, and the system detects that the voltage has reached baseline, the alert may be sent to a manager's device for immediate action. In this way, a smart beverage coaster may be an invaluable assistance device to service staff and management. Customers may be provided prompt but nonintrusive service.

FIG. 10 is a plan view of an example of a beverage server GUI 910, which may be presented on a beverage server device 908 of the beverage tracking system 900 of FIG. 9, according to some embodiments. The beverage server GUI 910 may display a list of apparatuses 100 that the beverage server GUI 910 is connected to. For example, the beverage server GUI 910 of FIG. 10 illustrates that the beverage server GUI 910 is connected to “smart coaster 1”, “smart coaster 2”, “smart coaster 3”, and “smart coaster 4”. The beverage server GUI 910 also indicates that the beverage server GUI 910 is ready to connect to other apparatuses 100. For example, the beverage server GUI 910 indicates that the beverage server GUI 910 is ready to connect to “smart coaster 5” and to “smart coaster 6”.

The beverage server GUI 910 also indicates estimates of the beverage levels of the beverage containers at each of the apparatuses 100. For example, the beverage server GUI 910 of FIG. 10 indicates that a beverage level at a beverage container at “smart coaster 1” is estimated to be about 10%, that a beverage level at a beverage container at “smart coaster 2” is estimated to be about 100%, that a beverage level at a beverage container at “smart coaster 3” is estimated to be about 80%, and that a beverage level at a beverage container at “smart coaster 4” is estimated to be about 30%. The beverage server GUI 910 also includes visual indicators of the beverage levels. For example, in the beverage server GUI 910 illustrated in FIG. 10, a beverage glass visual indicator above the percent full number includes a line to show an estimate of the beverage level.

The beverage server GUI 910 further identifies what beverage was provided to the beverage glass at each of the apparatuses 100. For example, the beverage server GUI 910 indicates that the beverage in the beverage glass at “smart coaster 1” is gyn and tonic. The beverage server GUI 910 also indicates that the beverage in the beverage glass at “smart coaster 2” is wheat beer. The beverage server GUI 910 indicates that the beverage in the beverage glass at “smart coaster 3” is vodka. Furthermore, the beverage server GUI 910 indicates that the beverage in the beverage glass at “smart coaster 4” is champagne.

The beverage server may be informed of beverage levels and beverage types at each of the apparatuses 100 merely by interacting with the list shown by the beverage server GUI 910 of FIG. 10. The beverage server GUI 910 also provides additional information and functionality responsive to a user selection of one of the listed beverages. For example, FIG. 11 and FIG. 12 show additional available information regarding the beverage glass at “smart coaster 1” responsive to a user selection of “smart coaster 1” in the beverage server GUI 910 of FIG. 10.

FIG. 11 is a plan view an example of the beverage server GUI 910 of FIG. 10 responsive to a user selection of a “smart coaster 1” option of the beverage server GUI 910 of FIG. 10. For example, as is apparent from FIG. 11, the beverage server GUI 910 is configured to provide an enlarged view of the visual indicator of the estimated beverage level of the beverage glass at “smart coaster 1”, as well as the numeric percentage beverage level of “10%”. In addition, the beverage server GUI 910 of FIG. 11 indicates a battery state of charge, which is 40% in the example illustrated in FIG. 11. The beverage server GUI 910 further indicates how long ago the last drink was served, which was three minutes ago in the example illustrated in FIG. beverage server GUI 910. As a result, by selecting one of the listed smart coasters from the beverage server GUI 910 of FIG. 10, the beverage server may obtain additional information above the beverage level, including battery state of charge and an amount of time since the last drink was served at the selected smart coaster.

The beverage server GUI 910 of FIG. 11 illustrates a “general” screen for the selected smart coaster device, as shown by the bold outline around the “general” selection at the bottom of the beverage server GUI 910. Other screens including a “stats” screen and a “controls” screen may be displayed responsive to a user selection of the “stats” selection or the “controls” selection at the bottom of the beverage server GUI 910.

FIG. 12 is a plan view of an example of the beverage server GUI 910 of FIG. 10 and FIG. 11 responsive to a user selection of the “stats” selection at the bottom of the beverage server GUI 910 of FIG. 10. Accordingly, the beverage server GUI 910 of FIG. 12 includes a “stats” screen. The “stats” screen illustrates a bar graph showing the beverage level in the beverage glass at “smart coaster 1” over time. For example, the bar graph shows that at 19:52 pm, the beverage level was estimated at 10%; at 19:53 pm, the beverage level was estimated at 2%; and at 19:54 pm and 19:55 pm the beverage level was estimated at 0%.

From the beverage server GUI 910 of FIG. 11 (the “general” screen) and FIG. 12 (the “stats” screen), the beverage server GUI 910 may be redirected back to the list view of FIG. 10 responsive to a user selection of the “device” option at the top of the screen.

In some embodiments, the “controls” option may redirect the beverage server GUI 910 to a user interface configured to facilitate connecting and disconnecting to apparatuses 100. For example, selection of the “controls” option may redirect the beverage server GUI 910 to access controls for a camera of the beverage server device 908 (FIG. 9) to enable the beverage server device 908 to read a bar code or a quick response (QR) code displayed by an apparatus 100 that the beverage server is connecting to their beverage server GUI 910.

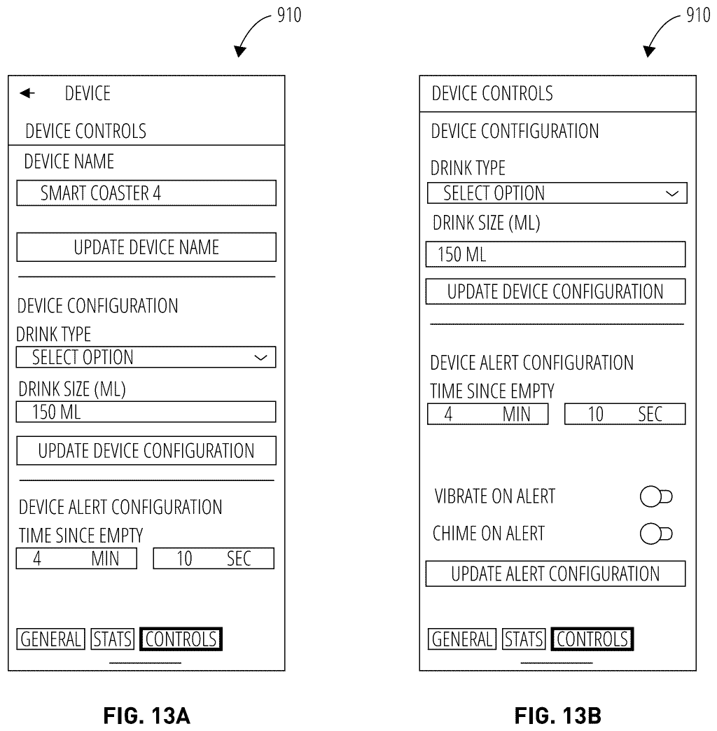

FIG. 13A and FIG. 13B illustrate a plan view of an example of the beverage server GUI 910 of FIG. 10 through FIG. 12 responsive to a user selection of the “controls” selection at the bottom of the beverage server GUI 910 of FIG. 10. The beverage server GUI 910 of FIG. 13A includes a “device controls” screen. The “controls screen” includes a text box for displaying the name of a selected apparatus 100 (e.g., “smart coaster 4” in the example of FIG. 13A). The device controls screen also includes a selection to update the device name, which may enable a beverage server to name and/or rename the selected apparatus 100. The device controls screen also includes device configuration options including a drop-down menu to enable selection of a drink type, a text box to enable a beverage server to input or select a drink size of the beverage in the beverage container supported by the selected apparatus 100, and an update device configuration option.

The device controls screen includes device alert configuration options, which include a time since empty indicator configured to indicate an amount of time since the beverage container on the selected apparatus 100 has been estimated to be empty.

FIG. 13B is a scrolled down version of the example of the beverage server GUI 910 illustrated in FIG. 13A. As illustrated in FIG. 13B, the device alert configuration options also include a vibrate on alert option and a chime on alert option to enable the beverage server to turn on and turn off vibration and chime alerts (e.g., to indicate an almost empty state (e.g., 20% full), an empty state, an empty for a predetermined period of time, etc.).

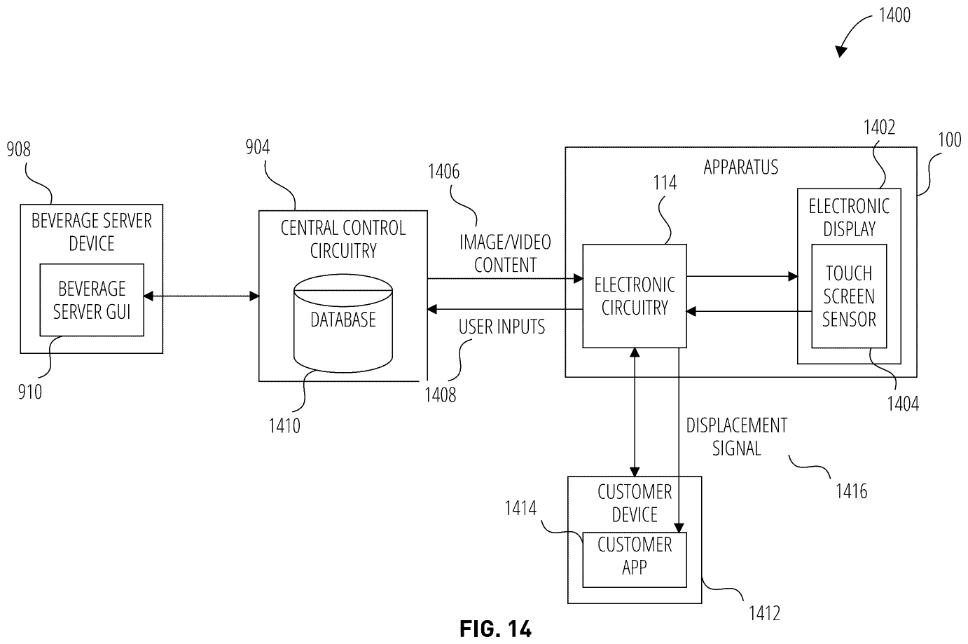

FIG. 14 is an example of another beverage tracking system 1400, according to some embodiments. The beverage tracking system 1400 includes the beverage server device 908, the central control circuitry 904, and the apparatus 100 discussed above. As previously discussed, the apparatus 100 includes electronic circuitry 114. In some embodiments, the apparatus 100 also includes an electronic display 1402 (e.g., an LCD screen). By way of non-limiting example, the first member 102 of the apparatus 100 of FIG. 1A through FIG. 1K includes an electronic display 1402. Accordingly, a customer may view images and/or video displayed on the touch screen sensor 1404 by looking at the planar surface 104 of the first member 102. The electronic display 1402 may be used to display advertisements, daily specials, or other promotions. The electronic display 1402 may also be used to alert customers of an approaching establishment closing time.

In some embodiments, the electronic display 1402 includes a touch screen sensor 1404 to enable the electronic circuitry 114 to provide a graphical user interface (GUI). In some embodiments, the GUI is configured to enable a person to order one or more of beverages or food. By way of non-limiting example, a “reorder” button may be provided by the GUI at the electronic display 1402 to make it easy for the customer to order a refill automatically when their drink is close to empty. In some embodiments, the GUI is configured to present a user-selectable option to request assistance from a beverage server, which may trigger an alert on the beverage server GUI 910 running on the beverage server device 908.

In some embodiments, the GUI at the electronic display 1402 is configured to provide an alert to replace the beverage container on the at least substantially planar surface. By way of non-limiting example, the electronic display 1402 may display a message indicating that better service will be provided if the beverage container is kept on the apparatus 100. Also by way of non-limiting example, a flashing indicator may be used to alert a customer to return the beverage container to the apparatus 100. In some embodiments, the GUI may be configured to enable the customer to close and pay a bill with or without intervention from the beverage server.

In some embodiments, the central control circuitry 904 may be configured to provide, to the electronic circuitry 114, image/video content to be displayed by the electronic display 1402. The electronic circuitry 114 may also be configured to provide any user inputs 1408 received from the touch screen sensor 1404 to the central control circuitry 904.

For customers, smart beverage coasters (e.g., the apparatus 100) may personalize the drinking experience. By tracking beverage consumption habits, smart beverage coasters may offer recommendations (e.g., on the electronic display 1402) for drinks based on past preferences or suggest food pairings that complement their choice of beverage. For example, the central control circuitry 904 may maintain a database including data corresponding to drink names, drink paces (e.g., amount of time to finish drinks, amount of drinks per sip, etc.) for customers. This level of personalized service not only enhances the customer's experience but can also encourage exploration of the menu, leading to a more satisfying and diverse dining experience. Additionally, the health-conscious customer may benefit from tracking their alcohol consumption over time, offering insights into drinking habits and facilitating more informed decisions about alcohol intake. This data may be integrated with health apps to contribute to a broader understanding of one's lifestyle and health choices. By leveraging the data from smart beverage coasters, businesses may create a more engaging, efficient, and personalized service, turning every sip into an opportunity to understand and serve customers better, while customers gain a tool that supports more informed and enjoyable dining experiences.

The ability of a smart beverage coaster to record (e.g., in the database 1410) detailed consumption metrics, such as the time it takes to consume different types of drinks, the size of the beverage, and the size of sips, opens up several avenues for data utilization that can benefit both businesses and customers. For example, businesses may be enabled to identify which drinks are consumed more rapidly or more slowly, helping to tailor the menu to customer preferences and potentially develop new beverage offerings that better align with those preferences. Also, analyzing the consumption rate and sip sizes could inform dynamic pricing strategies. For example, faster-consumed drinks might be priced differently than those savored more slowly, or promotions may be designed around more popular beverages to increase (e.g., maximize) sales during certain hours. Also, understanding popular drinks and consumption patterns may enable more efficient inventory management, ensuring that ingredients for faster-moving beverages are always in stock and reducing waste of products that sell less.

Data collected using smart beverage coasters may be stored in the database 1410 and used to improve a customer experience by suggesting drinks (e.g., on the electronic display 1402) based on individualized preferences or historical data, creating a more personalized service. Insights into sip sizes and drink duration can also help in crafting drinks that are better suited to different drinking paces, enhancing overall satisfaction. Knowing an average time taken to consume different drinks may help in timing service rounds more effectively, ensuring that staff may attend to customers that might be ready for another drink. Also, detailed consumption data enables targeted marketing efforts, such as promotions on drinks that are typically consumed more quickly, encouraging customers to try other options based on their consumption habits (e.g., by making drink suggestions on the electronic display 1402).

For health-conscious customers or establishments promoting responsible drinking, this data can offer insights into drinking habits, supporting efforts to moderate consumption or understand the impact of alcohol over time. By leveraging the detailed data captured by smart coasters (e.g., the apparatus 100), businesses may not only enhance operational efficiencies and the customer experience but also foster a deeper understanding of consumer behavior, paving the way for innovative service approaches and product offerings in the hospitality industry.

The use of smart beverage coasters (e.g., the apparatus 100) has the potential to significantly enhance the safety and responsibility of alcohol consumption in bars and restaurants. By integrating technology that tracks and communicates the amount of alcohol a customer has consumed, these smart beverage coasters may serve as a valuable tool in promoting responsible drinking behaviors and ensuring customer safety.

For example, in California, individuals involved in the sale, preparation, or service of alcohol are often required to be certified through a Responsible Beverage Service (RBS) Training Program as mandated by the California Department of Alcoholic Beverage Control (ABC). This requirement aims to ensure that servers are educated on the legalities and responsibilities involved in serving alcohol, including checking IDs, understanding the effects of alcohol, and handling situations involving intoxicated patrons responsibly. The idea of extending the certification period from one year to two years with the adoption of technology like smart beverage coasters and apparatuses 100 according to embodiments disclosed herein is an interesting proposition. Smart beverage coasters may theoretically enhance responsible service practices by providing at least substantially real-time data on consumption, helping to prevent over-serving, and potentially identifying underage or intoxicated patrons more effectively.

Smart beverage coasters (e.g., the apparatus 100) could calculate the volume of alcohol consumed based on the type and number of drinks served. This data could then be used to estimate the customer's Blood Alcohol Content (BAC), taking into account factors like the time over which drinks were consumed. By providing real-time feedback to customers (e.g., on the electronic display 1402) about their estimated BAC and how it compares to the legal driving limit, smart beverage coasters may educate customers on the effects of alcohol consumption and the importance of spacing out drinks. This awareness could encourage more responsible drinking choices. By way of non-limiting example, the electronic display 1402 may display an estimate of the customer's BAC based on the monitoring of the customer's alcohol consumption and provide alerts advising against driving and operating heavy machinery if the estimated BAC falls within certain thresholds (e.g., legal limits).

For customers who are approaching or have exceeded the legal limit for safe driving, the smart beverage coaster may display, on the electronic display 1402, a warning message advising against driving. It could also provide, on the electronic display 1402, information on the amount of time typically needed to metabolize the consumed alcohol to safe levels. In situations where a customer's estimated BAC is above the legal driving limit, the smart coaster may offer to facilitate transportation alternatives. By way of non-limiting example, the central control circuitry 904 may communicate with ride share or taxi software applications and/or websites to enable the customer to arrange a ride using the GUI at the electronic display 1402. By integrating with ridesharing apps like Uber or Lyft, the smart beverage coaster could make it easy for customers to call for a ride directly from their table, reducing the temptation to drive under the influence.

By actively participating in the promotion of safe drinking and providing practical solutions for transportation when alcohol consumption might impair driving ability, establishments using smart beverage coasters according to embodiments of the disclosure contribute to broader public safety efforts. This proactive approach may also positively reflect on the establishment's commitment to customer care and responsibility. The implementation of such technology would not only augment the dining experience with innovative features but also play a crucial role in promoting responsible alcohol consumption and enhancing road safety. It represents a convergence of technology and hospitality, aiming to ensure enjoyable yet safe experiences for patrons.

Other content that may be provided at the electronic display 1402 may include interactive games and trivia, free drink lucky draws, a user-selectable option to buy everyone at the table a round of drinks, happy hour/last call notifications, display of enticing short videos of appetizers, entrees, and desserts as customers progress through their courses, and real-time feedback on the electronic display 1402 before patrons leave the establishment.

In some embodiments, the beverage tracking system 1400 includes a customer device 1412 (e.g., a smartphone or tablet of the customer) executing a customer software application (customer app 1414). In some embodiments, the customer app 1414 is configured to record beverage consumption data based on a displacement signal 1416 (similar to the displacement signals 902 discussed with reference to FIG. 9) on the customer device 1412 (e.g., on a data storage device of the customer device 1412). Integrating a smartphone app (e.g., customer app 1414) with a smart beverage coaster (e.g., the apparatus 100) to track drink consumption and calorie intake over an extended period (e.g., a year) may offer several possibilities. For example, each smart beverage coaster (e.g., the apparatus 100) may be equipped with wireless communication capabilities (e.g., Bluetooth) to connect with the customer app 1414 executed on the customer device 1412. This connection may enable the transfer of data from the smart beverage coaster to the customer device 1412. If the customer chooses, the customer app 1414 may assist by alerting the customer if their rate of alcohol consumption is rapid and may also notify the customer as to when it isn't safe to drive a motor vehicle. By using personal data such as weight and consumption patterns, the customer device 1412 may provide a more personalized real-time estimate of Blood Alcohol Content (BAC), enhancing the user's ability to make informed decisions about their alcohol consumption.

In some embodiments, the smart beverage coaster (e.g., the apparatus 100) may identify the type of drink (possibly through input from the customer via the GUI at the electronic display 1402 or the customer device 1412 or from the server at the beverage server GUI 910 of FIG. 9) and estimate the calorie count based on standard drink sizes and types. This information may then be transmitted to the customer device 1412. The customer device 1412 may store consumption data over long periods, allowing customers to track their drinking habits and calorie intake over time. This data may be visualized in the customer device 1412 through graphs or charts, showing trends and patterns.

In some embodiments, customers may set personal goals for their drinking habits, like limiting intake to a certain number of drinks per week or keeping within a calorie range. The customer app 1414 may notify them when they are approaching or exceeding these limits. In some embodiments, the customer app 1414 may integrate with other health and fitness apps to provide a more comprehensive view of the customer's health and fitness regimen, taking into account the calorie intake from drinks.

In some embodiments, the customer app 1414 may include social features, allowing users to connect with friends, share achievements, and even compete in friendly challenges based on responsible drinking goals.

In some embodiments, the customer app 1414 may use strong privacy and security measures to protect user data, with clear user consent and data use policies.

In some embodiments, the customer app 1414 may offer personalized recommendations for new drinks, non-alcoholic alternatives, or suggestions for healthier choices. In some embodiments, a rewards system may be implemented where customers earn points for sticking to their goals, which may be redeemed for discounts or special offers. In some embodiments, the customer app 1414 may provide educational content about responsible drinking, the effects of alcohol, and tips for healthier alcohol consumption. By providing valuable insights into their drinking habits and calorie intake, the customer app 1414 may help customers make more informed choices about their alcohol consumption, potentially leading to healthier habits. This may also enhance customer engagement and loyalty to the establishments using the smart beverage coaster (e.g., the apparatus 100).

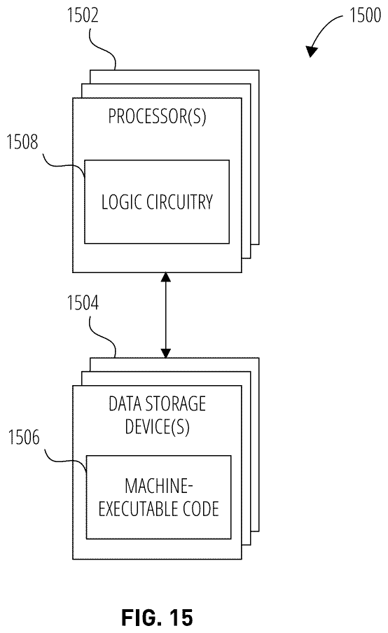

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 15 illustrates non-limiting examples of implementations of functional elements disclosed herein. In some embodiments, some or all portions of the functional elements disclosed herein may be performed by hardware specially configured for carrying out the functional elements.

FIG. 15 is a block diagram of circuitry 1500 that, in some embodiments, may be used to implement various functions, operations, acts, processes, and/or methods disclosed herein. The circuitry 1500 includes one or more processors 1502 (sometimes referred to herein as “processors 1502”) operably coupled to one or more data storage devices (sometimes referred to herein as “storage 1504”). The storage 1504 includes machine-executable code 1506 stored thereon and the processors 1502 include logic circuitry 1508. The machine-executable code 1506 includes information describing functional elements that may be implemented by (e.g., performed by) the logic circuitry 1508. The logic circuitry 1508 is adapted to implement (e.g., perform) the functional elements described by the machine-executable code 1506. The circuitry 1500, when executing the functional elements described by the machine-executable code 1506, should be considered as special purpose hardware configured for carrying out functional elements disclosed herein. In some embodiments the processors 1502 may be configured to perform the functional elements described by the machine-executable code 1506 sequentially, concurrently (e.g., on one or more different hardware platforms), or in one or more parallel process streams.

When implemented by logic circuitry 1508 of the processors 1502, the machine-executable code 1506 is configured to adapt the processors 1502 to perform operations of embodiments disclosed herein. For example, the machine-executable code 1506 may be configured to adapt the processors 1502 to perform at least a portion or a totality of the operations discussed for the electronic circuitry 114 of FIG. 1A through FIG. 1K, FIG. 9, and FIG. 14; the central control circuitry 904 of FIG. 9 and FIG. 14; the beverage server GUI 910 of FIG. 9 through FIG. 14; and/or the customer app 1414 of FIG. 14.

The processors 1502 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 1506 (e.g., software code, firmware code, hardware descriptions) related to embodiments of the present disclosure. It is noted that a general-purpose processor (may also be referred to herein as a host processor or simply a host) may be a microprocessor, but in the alternative, the processors 1502 may include any conventional processor, controller, microcontroller, or state machine. The processors 1502 may also be implemented as a combination of computing devices, such as a combination of a DSP and a microprocessor, a plurality of microprocessors, one or more microprocessors in conjunction with a DSP core, or any other such configuration.

In some embodiments the storage 1504 includes volatile data storage (e.g., random-access memory (RAM)), non-volatile data storage (e.g., Flash memory, a hard disc drive, a solid state drive, erasable programmable read-only memory (EPROM), etc.). In some embodiments the processors 1502 and the storage 1504 may be implemented into a single device (e.g., a semiconductor device product, a system on chip (SOC), etc.). In some embodiments the processors 1502 and the storage 1504 may be implemented into separate devices.

In some embodiments the machine-executable code 1506 may include computer-readable instructions (e.g., software code, firmware code). By way of non-limiting example, the computer-readable instructions may be stored by the storage 1504, accessed directly by the processors 1502, and executed by the processors 1502 using at least the logic circuitry 1508. Also by way of non-limiting example, the computer-readable instructions may be stored on the storage 1504, transferred to a memory device (not shown) for execution, and executed by the processors 1502 using at least the logic circuitry 1508. Accordingly, in some embodiments the logic circuitry 1508 includes electrically configurable logic circuitry 1508.

In some embodiments the machine-executable code 1506 may describe hardware (e.g., circuitry) to be implemented in the logic circuitry 1508 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1508 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine-executable code 1506 may include an HDL, an RTL, a GL description, a mask level description, other hardware description, or any combination thereof.

In embodiments where the machine-executable code 1506 includes a hardware description (at any level of abstraction), a system (not shown, but including the storage 1504) may be configured to implement the hardware description described by the machine-executable code 1506. By way of non-limiting example, the processors 1502 may include a programmable logic device (e.g., an FPGA or a PLC) and the logic circuitry 1508 may be electrically controlled to implement circuitry corresponding to the hardware description into the logic circuitry 1508. Also by way of non-limiting example, the logic circuitry 1508 may include hard-wired logic manufactured by a manufacturing system (not shown, but including the storage 1504) according to the hardware description of the machine-executable code 1506.

Regardless of whether the machine-executable code 1506 includes computer-readable instructions or a hardware description, the logic circuitry 1508 is adapted to perform the functional elements described by the machine-executable code 1506 when implementing the functional elements of the machine-executable code 1506. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. An apparatus to estimate an amount of a beverage in a beverage container, the apparatus comprising:
a first member including an at least substantially planar surface configured to support the beverage container thereon;
a second member configured to support the first member;
a displacement resistance mechanism configured to vary a displacement between the first member and the second member responsive to variations in forces pressing the first member and the second member together; and
a displacement sensor configured to generate a displacement signal that varies with the variation of the displacement between the first member and the second member.

2. The apparatus of claim 1, wherein the displacement sensor includes a variable resistor configured to vary an electrical resistance of the variable resistor responsive to variations in a displacement of the variable resistor.

3. The apparatus of claim 2, wherein the variable resistor comprises:
a resilient substrate material; and
an electrically resistive material carried by the resilient material, an electrical resistance of the electrically resistive material configured to increase as the displacement of the resilient substrate material increases.

4. The apparatus of claim 2, wherein at least one of the first member or the second member includes an actuator configured to displace the variable resistor responsive to the displacement between the first member and the second member.

5. The apparatus of claim 1, wherein the displacement resistance mechanism comprises one or more of springs, expanded foam, molded in features, elastomeric balls, or an elastomeric ring between the first member and the second member.

6. The apparatus of claim 1, wherein the apparatus is supported within a recess in a table surface or a counter surface and the at least substantially planar surface is at least substantially coplanar with the table surface or the counter surface.

7. The apparatus of claim 1, further comprising electronic circuitry configured to receive the displacement signal and provide the displacement signal to a beverage server device to enable the beverage server device to indicate, to a beverage server, an estimate of a beverage level of a beverage of the beverage container supported by the at least substantially planar surface.

8. The apparatus of claim 7, wherein the electronic circuitry is configured to communicate the displacement signal to at least one of a central control circuitry or a customer device.

9. The apparatus of claim 8, wherein the customer device includes a customer software application configured to record beverage consumption data based on the displacement signal on the customer device.

10. The apparatus of claim 1, wherein the apparatus is implemented as a beverage coaster.

11. The apparatus of claim 1, wherein the apparatus is implemented as a beverage bottle support at a beverage bottle storage position.

12. The apparatus of claim 1, wherein the first member includes an electronic display.

13. The apparatus of claim 12, wherein electronic circuitry of the apparatus is configured to provide a graphical user interface on the electronic display, the electronic display including a touch screen sensor.

14. The apparatus of claim 13, wherein the graphical user interface is configured to enable a person to order one or more of beverages or food.

15. The apparatus of claim 13, wherein the graphical user interface is configured to present a user-selectable option to request assistance from a server.

16. The apparatus of claim 13, wherein the graphical user interface is configured to provide an alert to replace the beverage container on the at least substantially planar surface.

17. A beverage tracking system, comprising:
an apparatus configured to support a beverage container thereon and provide a displacement signal indicating an estimated beverage level of a beverage in the beverage container; and
a beverage server device configured to provide a beverage server graphical user interface (GUI), the beverage server GUI configured to indicate the estimated beverage level.

18. The beverage tracking system of claim 17, wherein the beverage server GUI is further configured to indicate what beverage is in the beverage container.

19. The beverage tracking system of claim 17, wherein the beverage server GUI is further configured to indicate a state of charge of a battery powering the apparatus.

20. The beverage tracking system of claim 17, wherein the beverage server GUI is further configured to indicate one or more of:
an amount of time since a last beverage was provided to the beverage container; or
an amount of time that the beverage container has been empty.
